(19) United States
(12) Patent Application Publication
(10) Pub. No.: US 2018/0065736 A1
(43) Pub. Date: Mar. 8, 2018

(54) FIXED ROTOR THRUST VECTORING

(71) Applicant: CyPhy Works, Inc., Danvers, MA (US)

(72) Inventor: Kenneth D. SEBESTA, Winchester, KY (US)

(73) Assignee: CyPhy Works, Inc., Danvers, MA (US)

(21) Appl. No.: 15/316,011

(22) PCT Filed: Jun. 3, 2015
(86) PCT No.: PCT/US2015/033992

§ 371 Date: Dec. 2, 2016

Related U.S. Application Data
(60) Provisional application No. 62/007,160, filed on Jun. 3, 2014.

(51) Int. Cl. B64C 27/12; B64C 27/08; B64D 47/08

(52) U.S. Cl. CPC B64C 27/12; B64D 47/08; B64C 27/08

(57) ABSTRACT

An aerial vehicle includes a body having a center and a number of spatially separated thrusters. The spatially separated thrusters are statically coupled to the body at locations around the center of the body and are configured to emit thrust along a number of thrust vectors. The thrust vectors have a number of different directions with each thruster configured to emit thrust along a different one of the thrust vectors. One or more of the thrust vectors have a component in a direction toward the center of the body or away from the center of the body.

### RELATED APPLICATIONS

This application claims priority to, and the benefit of, Provisional Application Ser. No. 62/007,160, filed Jun. 3, 2014, which is hereby incorporated by reference in it entirety.

### FIELD OF THE INVENTION

This invention relates to an aerial vehicle.

### BACKGROUND

This invention relates to vectoring thrust.

Very generally, the term thrust vectoring relates to a manipulation of a direction of thrust produced by the engine(s) of a vehicle such as an airplane or rocket. One well known example of an aircraft that uses thrust vectoring is the Hawker Siddeley Harrier jet which uses thrust generated by its engine for both forward propulsion and vertical take-off and landing (VTOL) purposes. Another well known example of an aircraft that uses thrust vectoring is the Bell Boeing V-22 Osprey which uses thrust generated by two rotors for both forward propulsion and VTOL purposes.

In both the Hawker Siddeley Harrier jet and the Bell Boeing V-22 Osprey, thrust vectoring is accomplished by either redirecting thrust (e.g., using a thrust redirection nozzle) or by physically rotating the rotor(s) (e.g., changing an angle of one or more rotors relative to the inertial frame of reference).

### SUMMARY

Multi-rotor vehicles (e.g. quadcopters, hexacopters, octocopters) generally have motors rigidly mounted to the airframe and control vehicle motion by adjusting thrust of individual motors based on an idealized model of all motors generating thrust in the vertical direction. This makes for a system which can only be controlled in roll, pitch, yaw, and net thrust. Such a multi-rotor vehicle can move in space by holding a particular roll or pitch angle and varying the net thrust. This approach can lead to system instability as the vehicle hovers. Hover quality can be improved by controlling each axis independently of the vehicle's roll and pitch.

Approaches described herein employ thrusters which are mounted to a multi-rotor helicopter frame with dihedral and twist. That is, the thrust directions are fixed, and not all parallel. Each thruster generates an individual thrust line which is generally not aligned with the thrust lines of other thrusters. Free-body analysis yields the forces and moments acting on the body from each thruster. The forces and moments are summed together to produce a unique mapping from motor thrust to net body forces and moments. A desired input including roll, pitch, and yaw moments and forward, lateral, and vertical thrusts can be received and used to calculate the necessary change in motor thrusts, and thus by extension motor speeds, to achieve the desired input.

Approaches described herein use statically mounted thrusters to develop net thrusts (e.g., a net horizontal or vertical thrust) without changing the net roll, pitch, and yaw torques.

Approaches described herein use statically mounted thrusters to develop net moments without changing net thrusts generated by the motors.

In an aspect, in general, an aerial vehicle includes a body having a center and a number of spatially separated thrusters. The spatially separated thrusters are statically coupled to the body at locations around the center of the body and are configured to emit thrust along a number of thrust vectors. The thrust vectors have a number of different directions with each thruster configured to emit thrust along a different one of the thrust vectors. One or more of the thrust vectors have a component in a direction toward the center of the body or away from the center of the body.

Aspects may have one or more of the following features.

The thrust vectors may be emitted in six different directions. The thrust vectors may be emitted in eight different directions. The thrust vectors may be emitted in ten different directions. The thrusters may be distributed symmetrically about the center of the body. The thrusters may be distributed on a plane defined by the body.

All of the thrust vectors may have a shared primary component in a first direction. The first direction is may be a vertical direction. The aerial vehicle may include a controller configured to receive a control signal characterizing a desired spatial position for the aerial vehicle and a desired spatial orientation for the aerial vehicle, determine a net force vector and a net moment vector based on the received control signal, and cause the thrust generators to generate the net force vector and the net moment vector.

The controller may be further configured to cause the thrust generators to vary the net force vector while maintaining the net moment vector. The controller may be further configured to cause the thrust generators to vary the net moment vector while maintaining the net force vector. The body may include a number of spars and each thruster of the number of thrusters is statically coupled to an end of a different one of the spars.

Each thruster may include a motor coupled to a propeller. The motors of a first subset of the number of thrusters may rotate in a first direction and the motors of a second subset of the number of thrusters may rotate in a second direction, different from the first direction. The motors for all of the thrusters may rotate in a same direction. The motors of a first subset of the number of thrusters may have a first maximum rotational velocity and the motors of a second subset of the number of thrusters may have a second maximum rotational velocity, less than the first maximum rotational velocity. At least some of the thrusters may be coupled to the body at a dihedral angle relative to the body.

At least some thrusters may be coupled to the body at a twisted angle relative to the body. The aerial vehicle may include an imaging sensor coupled to the body. The aerial vehicle may include an aerodynamic body covering disposed on the body. The imaging sensor may be statically coupled to the body. The imaging sensor may be coupled to the body using a gimbal. The imaging sensor may include a still camera. The imaging sensor may include a video camera.

In some aspects, the aerial vehicle is configured to maintain a desired spatial orientation while at the same time generating a net thrust that varies in magnitude and/or direction). In some aspects, a sensor such as a still or video camera is statically coupled to the multi-rotor vehicle and an orientation of the vehicle is maintained such that the camera remains pointed in a given direction while the net thrust vector generated by the vehicle causes the vehicle to move in space.

Aspects may include one or more of the following advantages.

Among other advantages, approaches allow for a decoupling of the positional control of the multi-rotor helicopter from the rotational control of the multi-rotor helicopter. That is, the position of the multi-rotor helicopter can be controlled independently of the rotation of the multi-rotor helicopter.

Dynamic in-air stability is improved and the number of parts necessary to orient a camera at a given angle is reduced. This leads to cheaper, more robust models that perform better in a wide variety of conditions.

By using motors that all rotate in the same direction, the number of unique parts required to build the aerial vehicle is reduced, resulting in a reduced cost for the aerial vehicle.

Other features and advantages of the invention are apparent from the following description, and from the claims.

### DESCRIPTION OF DRAWINGS

FIG. 1 is a perspective view of a multi-rotor helicopter.

FIG. 2 is a side view of a multi-rotor helicopter.

FIG. 3 is a detailed view of a thruster of the multi-rotor helicopter.

FIG. 4 is a block diagram of a control system.

FIG. 5 shows the multi-rotor helicopter operating in the presence of a prevailing wind.

FIG. 6 shows the multi-rotor helicopter rotating without changing its position.

FIG. 7 shows the multi-rotor helicopter including a gimbaled imaging sensor hovering.

FIG. 8 is a plot showing a roll and pitch controllability envelope in Nm at various weights, with no lateral thrust being generated.

FIG. 9 is a plot showing a roll and pitch controllability envelope in Nm at various weights with a 1 m/s² rightward thrust being generated.

FIG. 10 is a plot showing a roll and pitch controllability envelope in Nm at various weights with a 1 m/s² forward thrust being generated.

FIG. 11 is a plot showing a roll and pitch controllability envelope in Nm at various weights with a 1 m/s² forward thrust and 1 m/s² right thrust being generated.

### DESCRIPTION

### 1 Multi-Rotor Helicopter Physical Configuration

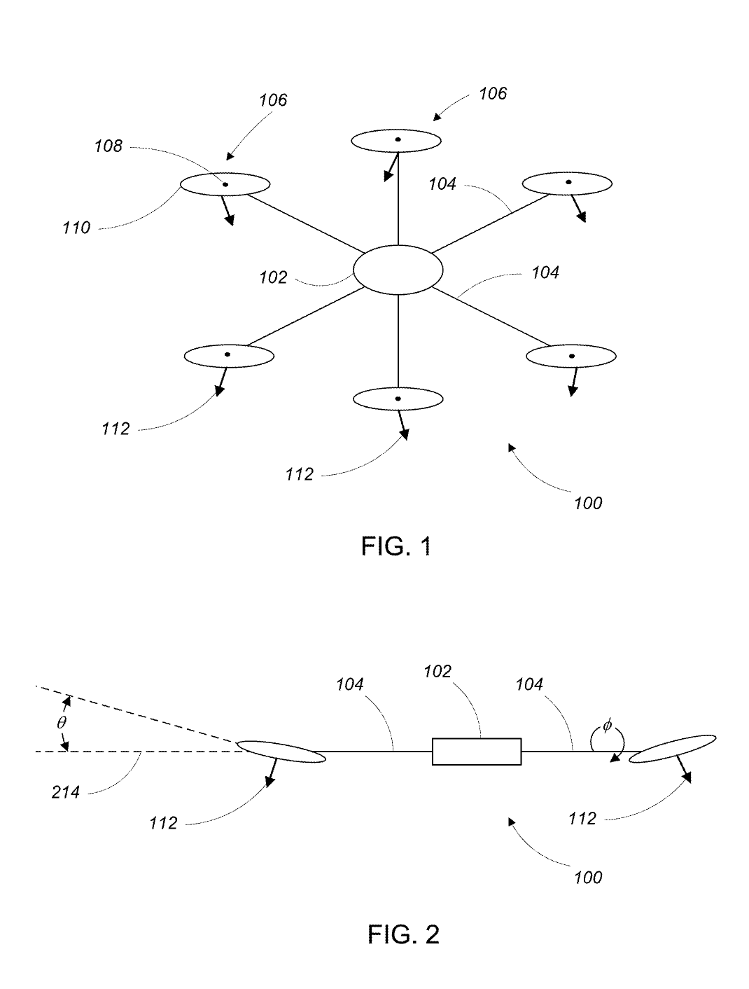

Referring to FIG. 1, a multi-rotor helicopter 100 includes a central body 102 from which a number (i.e., n) of rigid spars 104 radially extend. The end of each rigid spar 104 includes a thruster 106 rigidly mounted thereon. In some examples, each of the thrusters 106 includes an electric motor 108 (e.g., a brushless DC motor) which drives a rotor 110 to generate thrust. Very generally, in operation the central body 102 includes a power source (not shown) which provides power to the motors 108 which in turn cause the rotors 110 to rotate. While rotating, each of the rotors 110 forces air above the helicopter 100 in a generally downward direction to generate a thrust having a magnitude and direction that can be represented as a thrust vector 112.

Referring to FIG. 2, in contrast to conventional multi-rotor helicopter configurations, the multi-rotor helicopter 100 of FIG. 1 has each of its thrusters 106 rigidly mounted with both a dihedral angle, θ and a twist angle, φ. In some examples, both (1) the dihedral angle is the same for each spar 104, and (2) the magnitude of the twist angle is the same for each spar 104 with the sign of the twist angle being different for at least some of the spars 104. To understand the mounting angles of the thrusters 106, it is helpful to consider the plane defined by the rigid spars 104 of the multi-rotor helicopter 100 as being a horizontal plane 214. With this in mind, mounting the thrusters 106 with a dihedral angle includes mounting the thrusters 106 at an angle, θ with respect to a line from the center of the rotor 110 to the center of the central body 102. Mounting a thruster 106 with a twist angle at the end of a rigid spar 104 includes mounting the thrusters 106 at an angle, φ such that they are rotated about a longitudinal axis of the rigid spar 104.

Due to the dihedral and twist mounting angles of the thrusters 106, the thrust vectors 112 are not simply perpendicular to the horizontal plane 214 defined by the rigid spars 104 of the multi-rotor helicopter 100. Instead, at least some of the thrust vectors have a direction with an oblique angle to the horizontal plane 214. The thrust force vectors, F̅ᵢ̅ are independent (i.e., no force vector is a multiple of other of the force vectors) or there are at least k (e.g., k=3, 6, etc.) independent thrust force vectors.

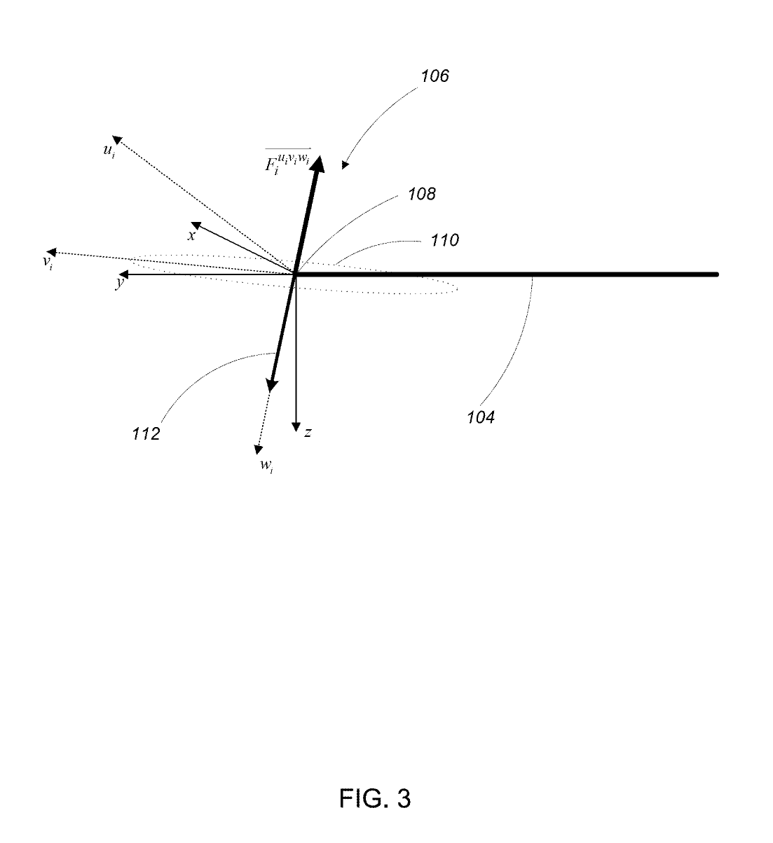

Referring to FIG. 3, a detailed view of an i^{th} thruster 106 shows two different coordinate systems: an x, y, z coordinate system and a uᵢ, vᵢ, wᵢ coordinate system. The x, y, z coordinate system is fixed relative to the vehicle and has its z axis extending in a direction perpendicular to the horizontal plane defined by the rigid spars 104 of the multi-rotor helicopter 100. The x and y axes extend in a direction perpendicular to one another and parallel to the horizontal plane defined by the rigid spars 104. In some examples, the x, y, z coordinate system is referred to as the “vehicle frame of reference.” The uᵢ, vᵢ, wᵢ coordinate system has its wᵢ axis extending in a direction perpendicular to a plane defined by the rotating rotor 110 of the i^{th} thruster 106 and its uᵢ axis extending in a direction along the i^{th} spar 104. The uᵢ and vᵢ axes extend in a direction perpendicular to one another and parallel to the horizontal plane defined by the rotating rotor 110. In some examples, the uᵢ, vᵢ, wᵢ coordinate system is referred to as the “rotor frame of reference.” Note that the x, y, z coordinate system is common for all of the thrusters 106 while the uᵢ, vᵢ, wᵢ is different for each (or at least some of) the thrusters 106.

The rotational difference between the x, y, z and the uᵢ, vᵢ, wᵢ coordinate systems for each of the n thrusters 106 can be expressed as a rotation matrix Rᵢ. In some examples, the rotation matrix Rᵢ can be expressed as the product of three separate rotation matrices as follows:

Rᵢ=Rᵢ^{φ}Rᵢ^{θ}Rᵢ^{φ}

where Rᵢ^{φ} is the rotation matrix that accounts for the rotation of the i^{th} spar relative to the x, y, z coordinate system, Rᵢ^{θ} is the rotation matrix that accounts for the dihedral angle, θ relative to the x, y, z coordinate system, and Rᵢ^{φ} is the rotation matrix that accounts for the twist angle, φ relative to the x, y, z coordinate system.

Very generally, multiplying an arbitrary vector in the uᵢ, vᵢ, wᵢ coordinate system by the rotation matrix Rᵢ results in a representation of the arbitrary vector in the x, y, z coordinate system. As is noted above, the rotation matrix Rᵢ at the i^{th} spar depends on the spar number, i, the dihedral angle, θ, and the twist angle, φ. Since each spar has its own unique spar number, i, dihedral angle, θ, and twist angle, φ, each spar has a different rotation matrix, Rᵢ. One example of a rotation matrix for a second spar with a dihedral angle of 15 degrees and a twist angle of −15 degrees is

$$[ \begin{matrix}0.4830 & - 0.8700 & - 0.0991 \\ 0.8365 & 0.4250 & 0.3459 \\ - 0.2588 & - 0.2500 & 0.9330\end{matrix} ]$$

In general, the ith thrust vector 112 can be represented as a force vector, [symbol] 113. The force vector, [symbol] 113 generated by the ith thruster 106 extends only along the wᵢ axis of the uᵢ, vᵢ, wᵢ coordinate system for the ith thruster 106. Thus, the ith force vector 113 can be expressed as:

$$\overline{{F}_{i}^{{u}_{i} {v}_{i} {w}_{i}}} = [ \begin{matrix}0 \\ 0 \\ {f}_{i}\end{matrix} ]$$

where fᵢ represents the magnitude of the i^{th} force vector 113 along the wᵢ axis of the uᵢ, vᵢ, wᵢ coordinate system. In some examples, fᵢ is expressed as:

fᵢ≈k₁ωᵢ²

where k₁ is an experimentally determined constant and ωᵢ² is the square of the angular speed of the motor 108.

The components of i^{th} force vector 113 in the x, y, z coordinate system can be determined by multiplying the i^{th} force vector 113 by the i^{th} rotation matrix Rᵢ as follows:

$$\vec{{F}_{i}^{xyz}} = {R}_{i} \vec{{F}_{i}^{{u}_{i} {v}_{i} {w}_{i}}} = {R}_{i} [ \begin{matrix}0 \\ 0 \\ {f}_{i}\end{matrix} ]$$

where [symbol] is a vector representation of the i^{th} force vector 113 in the x, y, z coordinate system.

The moment due to the i^{th} thruster 106 includes a motor torque component due to the torque generated by the thruster's motor 108 and a thrust torque component due to the thrust generated by the rotor 110 of the thruster 106. For the i^{th} thruster 106, the motor rotates about the wᵢ axis of the uᵢ, vᵢ, wᵢ coordinate system, generating a rotating force in the uᵢ, vᵢ plane. By the right hand rule, the motor torque generated by the i^{th} thruster's motor 108 is a vector having a direction along the wᵢ axis. The motor torque vector for the i^{th} thruster can be expressed as:

$$\vec{{T}_{1 i}^{{u}_{i} {v}_{i} {w}_{i}}} = [ \begin{matrix}0 \\ 0 \\ {τ}_{i}\end{matrix} ]$$

where

τᵢ≈k₂ωᵢ²,

with k₂ being an experimentally determined constant, and ωᵢ² being the square of the angular speed of the motor 108.

To express the motor torque vector in the x, y, z coordinate system, the motor torque vector is multiplied by the rotation matrix Rᵢ as follows:

$$\vec{{T}_{1 i}^{xyz}} = {R}_{i} \vec{{T}_{1 i}^{{u}_{i} {v}_{i} {w}_{i}}} = {R}_{i} [ \begin{matrix}0 \\ 0 \\ {τ}_{i}\end{matrix} ]$$

The torque due to the thrust generated by the rotor 110 of the i^{th} thruster 106 is expressed as the cross product of the moment arm of the i^{th} thruster 106 in the x, y, z coordinate system, [symbol] and the representation of the i^{th} force vector 113 in the x, y, z coordinate system, [symbol] :

[symbol]

= [symbol] ×

[symbol]

where the moment arm is expressed as the length of the i^{th} spar 104 along the uᵢ axis of the uᵢ, vᵢ, wᵢ coordinate system multiplied by the spar rotation matrix, Rᵢ^{φ}.

$$\vec{{r}_{i}^{xyz}} = {R}_{i}^{ϕ} [ \begin{matrix}𝓁 \\ 0 \\ 0\end{matrix} ]$$

The resulting moment due to the i^{th} thruster 106 can be expressed as:

$$\vec{{M}_{i}} = \vec{{T}_{1 i}^{xyz}} + \vec{{T}_{2 i}^{xyz}} = {R}_{i} [ \begin{matrix}0 \\ 0 \\ {τ}_{i}\end{matrix} ] + {R}_{i}^{ϕ} [ \begin{matrix}𝓁 \\ 0 \\ 0\end{matrix} ] \times {R}_{i} [ \begin{matrix}0 \\ 0 \\ {f}_{i}\end{matrix} ]$$

The force vectors in the x, y, z coordinate system, [symbol] generated at each thruster 106 can be summed to determine a net thrust vector:

$$\vec{{F}^{xyz}} = {\sum }_{i = 1}^{n} \vec{{F}_{i}^{xyz}} = {\sum }_{i = 1}^{n} {R}_{i} [ \begin{matrix}0 \\ 0 \\ {f}_{i}\end{matrix} ]$$

By Newton's second law of motion, a net translational acceleration vector for the multi-rotor helicopter 100 can be expressed as the net force vector in the x, y, z coordinate system, \vec{F^{xyz}} divided by the mass, in of the multi-rotor helicopter 100. For example, for a multi-rotor helicopter 100 with n thrusters, the net translational acceleration vector can be expressed as:

$$\vec{a} = \frac{\vec{{F}^{xyz}}}{m} = \frac{1}{m} {\sum }_{i = 1}^{n} {R}_{i} [ \begin{matrix}0 \\ 0 \\ {f}_{i}\end{matrix} ]$$

The moments in the x, y, z coordinate system, \vec{Mᵢ^{xyz}} generated at each thruster 106 can be summed to determine a net moment:

$$\vec{{M}_{i}^{xyz}} = {\sum }_{i = 1}^{n} \vec{{M}_{i}^{xyz}} = {\sum }_{i = 1}^{n} ( {R}_{i} [ \begin{matrix}0 \\ 0 \\ {τ}_{i}\end{matrix} ] + {R}_{i}^{ϕ} [ \begin{matrix}𝓁 \\ 0 \\ 0\end{matrix} ] \times {R}_{i} [ \begin{matrix}0 \\ 0 \\ {f}_{i}\end{matrix} ] )$$

By Newton's second law of motion, a net angular acceleration vector for the multi-rotor helicopter 100 can be expressed as the sum of the moments due to the n thrusters divided by the moment of inertia, J of the multi-rotor helicopter 100. For example, for a multi-rotor helicopter 100 with n thrusters, the net angular acceleration can be expressed as:

$$\vec{a} = \frac{\vec{{M}_{i}^{xyz}}}{J} = \frac{1}{J} {\sum }_{i = 1}^{n} ( {R}_{i} [ \begin{matrix}0 \\ 0 \\ {τ}_{i}\end{matrix} ] + {R}_{i}^{ϕ} [ \begin{matrix}𝓁 \\ 0 \\ 0\end{matrix} ] \times {R}_{i} [ \begin{matrix}0 \\ 0 \\ {f}_{i}\end{matrix} ] )$$

Based on the above model of the multi-rotor helicopter 100, it should be apparent to the reader that the magnitudes and directions of the overall translational acceleration vector [symbol] and the overall angular acceleration vector [symbol] can be individually controlled by setting appropriate values for the angular speeds, ωᵢ for the motors 108 of each of the n thrusters 108.

### 2 Multi-Rotor Helicopter Control System

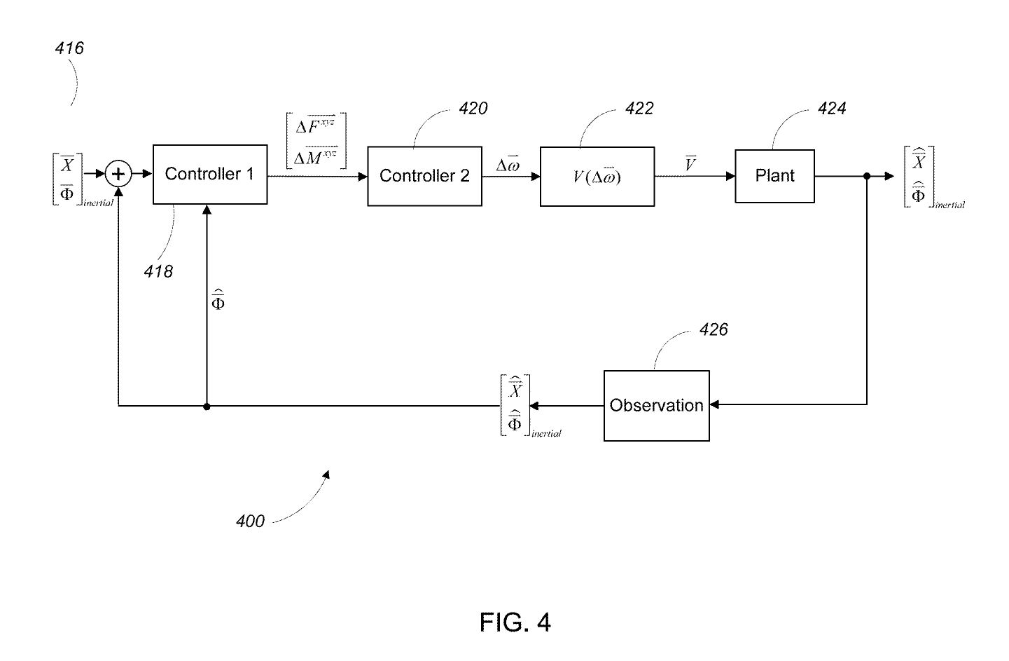

Referring to FIG. 4, in an exemplary approach to controlling a vehicle 100, a multi-rotor helicopter control system 400 receives a control signal 416 including a desired position, \vec{X} in the inertial frame of reference (specified as an n, w, h (i.e., North, West, height) coordinate system, where the terms “inertial frame of reference” and n, w, h coordinate system are used interchangeably) and a desired rotational orientation, [symbol] in the inertial frame of reference (specified as a roll (R), pitch (P), and yaw (Y) in the inertial frame of reference) and generates a vector of voltages [symbol] which are used to drive the thrusters 108 of the multi-rotor helicopter 100 to move the multi-rotor helicopter 100 to the desired position in space and the desired rotational orientation.

The control system 400 includes a first controller module 418, a second controller module 420, an angular speed to voltage mapping function 422, a plant 424 (i.e., the multi-rotor helicopter 100), and an observation module 426. The control signal 416, which is specified in the inertial frame of reference is provided to the first controller 418 which processes the control signal 416 to determine a differential thrust force vector, Δ [symbol] and a differential moment vector, Δ [symbol] , each specified in the frame of reference of the multi-rotor helicopter 100 (i.e., the x, y, z coordinate system). In some examples, differential vectors can be viewed as a scaling of a desired thrust vector. For example, the gain values for the control system 400 may be found using empiric tuning procedures and therefore encapsulates a scaling factor. For this reason, in at least some embodiments, the scaling factor does not need to be explicitly determined by the control system 400. In some examples, the differential vectors can be used to linearize the multi-rotor helicopter system around a localized operating point.

In some examples, the first controller 418 maintains an estimate of the current force vector and uses the estimate to determine the differential force vector in the inertial frame of reference, Δ [symbol] as a difference in the force vector required to achieve the desired position in the inertial frame of reference. Similarly, the first controller 418 maintains an estimate of the current moment vector in the inertial frame of reference and uses the estimate to determine the differential moment vector in the inertial frame of reference, Δ [symbol] as a difference in the moment vector required to achieve the desired rotational orientation in the inertial frame of reference. The first controller then applies a rotation matrix to the differential force vector in the inertial frame Δ [symbol] to determine its representation in the x, y, z coordinate system of the multi-rotor helicopter 100, Δ [symbol] . Similarly, the first controller 418 applies the rotation matrix to the differential moment vector in the inertial frame of reference, Δ [symbol] to determine its representation in the x, y, z coordinate system of the multi-rotor helicopter 100, Δ [symbol] .

The representation of the differential force vector in the x, y, z coordinate system, Δ [symbol] and the representation of the differential moment vector in the x, y, z coordinate system, Δ [symbol] are provided to the second controller 420 which determines a vector of differential angular motor speeds:

$$Δ \vec{ω} = [ \begin{matrix}Δ {ω}_{1} \\ Δ {ω}_{2} \\ ⋮ \\ Δ {ω}_{n}\end{matrix} ]$$

As can be seen above, the vector of differential angular motor speeds, Δ [symbol] includes a single differential angular motor speed for each of the n thrusters 106 of the multi-rotor helicopter 100. Taken together, the differential angular motor speeds represent the change in angular speed of the motors 108 required to achieve the desired position and rotational orientation of the multi-rotor helicopter 100 in the inertial frame of reference.

In some examples, the second controller 420 maintains a vector of the current state of the angular motor speeds and uses the vector of the current state of the angular motor speeds to determine the difference in the angular motor speeds required to achieve the desired position and rotational orientation of the multi-rotor helicopter 100 in the inertial frame of reference.

The vector of differential angular motor speeds, Δ [symbol] is provided to the angular speed to voltage mapping function 422 which determines a vector of driving voltages:

$$\vec{V} = [ \begin{matrix}{V}_{1} \\ {V}_{2} \\ ⋮ \\ {V}_{n}\end{matrix} ]$$

As can be seen above, the vector of driving voltages, [symbol] includes a driving voltage for each motor 108 of the n thrusters 106. The driving voltages cause the motors 108 to rotate at the angular speeds required to achieve the desired position and rotational orientation of the multi-rotor helicopter 100 in the inertial frame of reference.

In some examples, the angular speed to voltage mapping function 422 maintains a vector of present driving voltages, the vector including the present driving voltage for each motor 108. To determine the vector of driving voltages, [symbol] , the angular speed to voltage mapping function 422 maps the differential angular speed Δωᵢ for each motor 108 to a differential voltage. The differential voltage for each motor 108 is applied to the present driving voltage for the motor 108, resulting in the updated driving voltage for the motor, Vᵢ. The vector of driving voltages, [symbol] includes the updated driving voltages for each motor 108 of the i thrusters 106.

The vector of driving voltages, [symbol] is provided to the plant 424 where the voltages are used to drive the motors 108 of the i thrusters 106, resulting in the multi-rotor helicopter 100 translating and rotating to a new estimate of position and orientation:

$$[ \begin{matrix}\vec{X} \\ \vec{Φ}\end{matrix} ]$$

The observation module 426 observes the new position and orientation and feeds it back to a combination node 428 as an error signal. The control system 400 repeats this process, achieving and maintaining the multi-rotor helicopter 100 as close as possible to the desired position and rotational orientation in the inertial frame of reference.

### 3 Applications

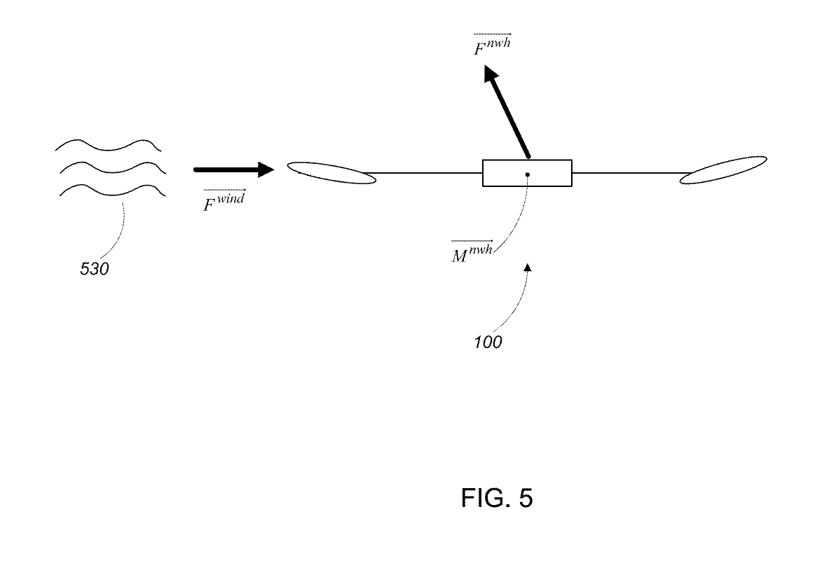

Referring to FIG. 5, in some examples, a multi-rotor helicopter 100 is tasked to hover at a given position [symbol] in the inertial frame of reference in the presence a prevailing wind 530. The wind causes exertion of a horizontal force, [symbol] _{wind} on the multi-rotor helicopter 100, tending to displace the multi-rotor helicopter in the horizontal direction. Conventional multi-rotor helicopters may have to tilt their frames into the wind and adjust the thrust generated by their thrusters to counter the horizontal force of the wind, thereby avoiding displacement. However, tilting the frame of a multi-rotor helicopter into wind increases the profile of the multi-rotor helicopter that is exposed to the wind. The increased profile results in an increase in the horizontal force applied to the multi-rotor helicopter due to the wind. The multi-rotor helicopter must then further tilt into the wind and further adjust the thrust generated by its thrusters to counter the increased wind force. Of course, further tilting into the wind further increases the profile of the multi-rotor helicopter that is exposed to the wind. It should be apparent to the reader that tilting a multi-rotor helicopter into the wind results in a vicious cycle that wastes energy.

The approaches described above address this issue by enabling motion of the multi-rotor helicopter 100 horizontally into the wind without tilting the frame of the multi-rotor helicopter 100 into the wind. To do so, the control system described above causes the multi-rotor helicopter 100 to vector its net thrust such that a force vector [symbol] is applied to the multi-rotor helicopter 100. The force vector [symbol] has a first component that extends upward along the h axis of the inertial frame with a magnitude equal to the gravitational constant, g exerted on the multi-rotor helicopter 100. The first component of the force vector [symbol] maintains the altitude of the multi-rotor helicopter 100 at the altitude associated with the given position. The force vector [symbol] has a second component extending in a direction opposite (i.e., into) the force exerted by the wind and having a magnitude equal to the magnitude of the force, [symbol] exerted by the wind. The second component of the force vector maintains the position of the multi-rotor helicopter 100 in the n, w plane of the inertial frame of reference.

To maintain its horizontal orientation [symbol] in the inertial frame of reference, the control system described above causes the multi-rotor helicopter 100 to maintain the magnitude of its moment vector [symbol] at or around zero. In doing so, any rotation about the center of mass of the multi-rotor helicopter 100 is prevented as the multi-rotor helicopter 100 vectors its thrust to oppose the wind.

In this way the force vector [symbol] and the moment vector [symbol] maintained by the multi-rotor helicopter's control system enable the multi-rotor helicopter 100 to compensate for wind forces applied thereto without rotating and increasing the profile that the helicopter 100 presents to the wind.

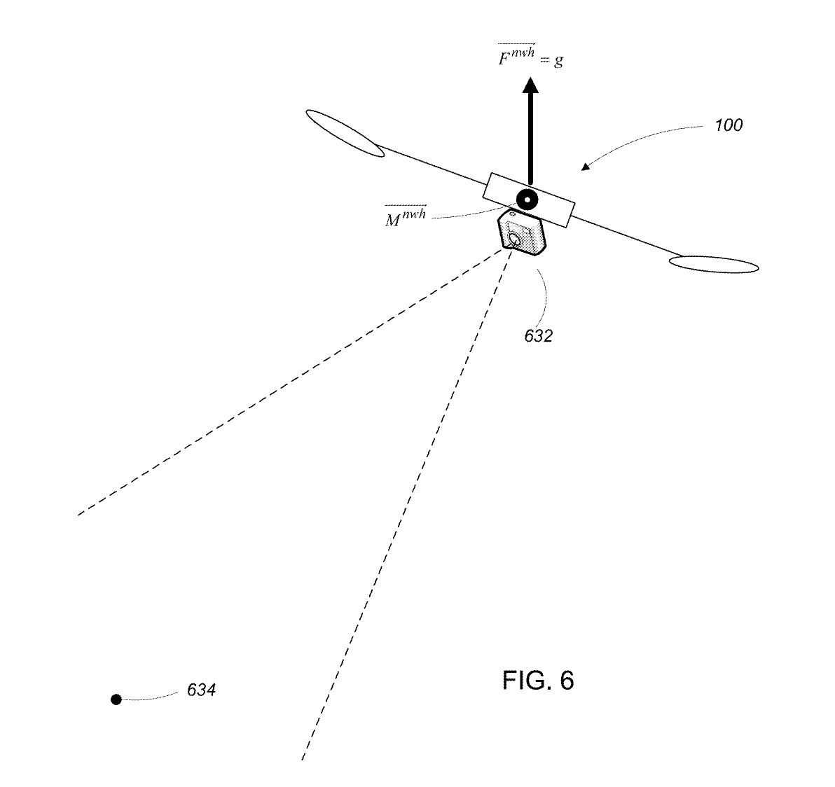

Referring to FIG. 6, it is often the case that an imaging sensor 632 (e.g., a camera) is attached to the multi-rotor helicopter 100 for the purpose of capturing images of a point of interest 634 on the ground beneath the multi-rotor helicopter 100. In general, it is often desirable to have the multi-rotor helicopter 100 hover in one place while the imaging sensor 632 captures images. Conventional multi-rotor helicopters are unable to orient the imaging sensor 632 without tilting their frames (and causing horizontal movement) and therefore require expensive and heavy gimbals for orienting their imaging sensors.

The approaches described above obviate the need for such gimbals by allowing the multi-rotor helicopter 100 to rotate its frame in the inertial plane while maintaining its position in the inertial plane. In this way, the imaging sensor 632 can be statically attached to the frame of the multi-rotor helicopter 100 and the helicopter can tilt its frame to orient the imaging sensor 632 without causing horizontal movement of the helicopter. To do so, upon receiving a control signal characterizing a desired imaging sensor orientation, [symbol] the control system described above causes the moment vector, [symbol] of the multi-rotor helicopter 100 to extend in a direction along the horizontal (n, w) plane in the inertial frame of reference, with a magnitude corresponding to the desired amount of rotation. To maintain the position, [symbol] of the multi-rotor helicopter 100 in the inertial frame of reference, the control system causes the multi-rotor helicopter 100 to vector its net thrust such that a force vector [symbol] is applied to the multi-rotor helicopter 100. The force vector [symbol] extends only along the h-axis of the inertial frame of reference and has a magnitude equal to the gravitational constant, g. By independently setting the force vector [symbol] and the moment vector [symbol] , the multi-rotor helicopter 100 can rotate about its center while hovering in one place.

As is noted above, conventional multi-rotor helicopters are controlled in roll, pitch, yaw, and net thrust. Such helicopters can become unstable (e.g., an oscillation in the orientation of the helicopter) when hovering in place. Some such helicopters include gimbaled imaging sensors. When a conventional helicopter hovers in place, its unstable behavior can require that constant maintenance of the orientation of gimbaled imaging sensor to compensate for the helicopter's instability.

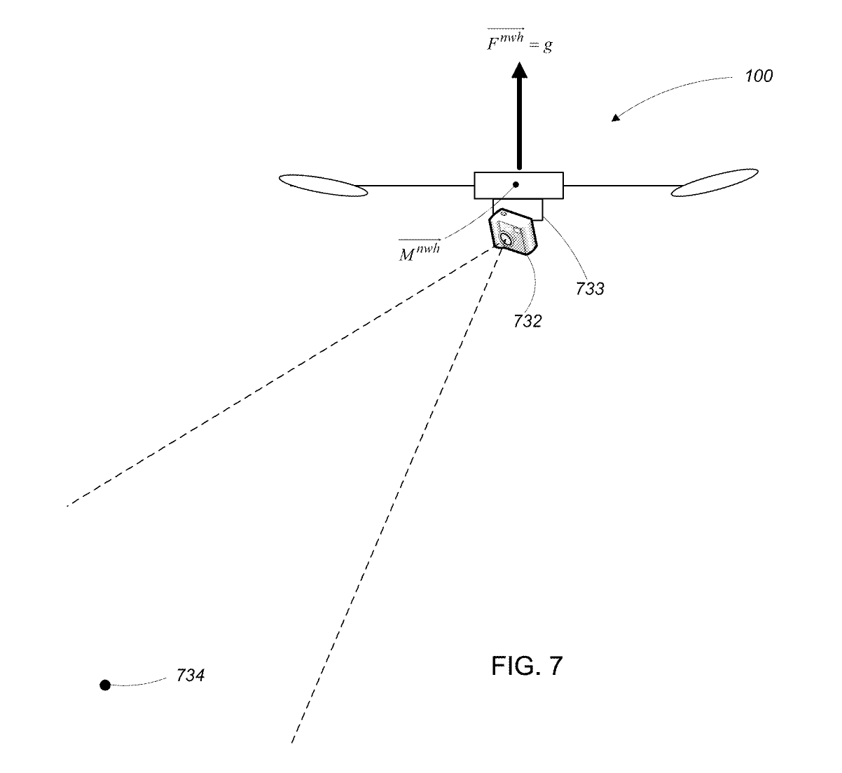

Referring to FIG. 7, the approaches described above advantageously reduce or eliminate the instability of a multi-rotor helicopter 100 when hovering by allowing for independent control of each axis of the helicopter's orientation. In FIG. 7, an imaging sensor 732 is attached to the multi-rotor helicopter 100 by a gimbal 733. The imaging sensor 732 is configured to capture images on the ground beneath the multi-rotor helicopter 100. In general, it is often desirable to have the multi-rotor helicopter 100 hover in one place while the imaging sensor 732 is captures images of a given point of interest 734.

To hover in one place with high stability, the multi-rotor helicopter 100 receives a control signal characterizing a desired spatial position, [symbol] and a desired spatial orientation, [symbol] for the multi-rotor helicopter 100. In the example of FIG. 7, the desired spatial orientation for the helicopter 100 has the helicopter hovering horizontally with respect to the inertial frame of reference.

The control system described above receives the control signal and maintains the spatial position, [symbol] of the multi-rotor helicopter 100 in the inertial frame of reference by causing the multi-rotor helicopter 100 to vector its net thrust such that a force vector [symbol] is applied to the multi-rotor helicopter 100. The force vector [symbol] extends only along the h-axis of the inertial frame of reference and has a magnitude equal to the gravitational constant, g.

The control system maintains the spatial orientation, [symbol] of the multi-rotor helicopter 100 by causing the multi-rotor helicopter 100 to vector its moment such that a moment vector, [symbol] has a magnitude of approximately zero. The control system maintains the force vector [symbol] and the moment vector [symbol] , such that the multi-rotor helicopter 100 hovers in place with high stability.

Due to the high stability of the hovering multi-rotor helicopter 100, little or no maintenance of the gimbal orientation is necessary to train the imaging sensor 732 on the point of interest 734.

### 4 Alternatives

In some examples, an aerodynamic body can be added to the multi-rotor helicopter to reduce drag due to prevailing winds.

While the above approaches describe a helicopter including multiple thrusters, other types of thrust generators could be used instead of the thrusters.

In some examples, a hybrid control scheme is used to control the multi-rotor helicopter. For example, in the example of FIG. 5, the multi-rotor helicopter may use the thrust vectoring approaches described above to maintain its position in the presence of light winds but may switch to a classical tilting strategy if the prevailing wind becomes too strong to overcome with the thrust vectoring approaches.

It is noted that the control system of FIG. 4 is only one example of a control system that can be used to control the multi-rotor helicopter and other control systems using, for example, non-linear special Euclidean group 3 (i.e., SE(3)) techniques, can also be used.

In the examples described above, a multi-rotor helicopter includes six thrust generators, each thrust generator generating thrust in a different direction from all of the other thrust generators. By generating thrust in six different directions, all of the forces and moments on the multi-rotor helicopter can be decoupled (i.e., the system can be expressed as a system of six equations with six unknowns). In some examples, the multi-rotor helicopter can include additional (e.g., ten) thrust generators, each generating thrust in a different direction from all of the other thrust generators. In such examples, the system is overdetermined, allowing for finer control of at least some of the forces and moments on the multi-rotor helicopter. In other examples, the multi-rotor helicopter can include fewer than six thrust generators, each generating thrust in a different direction from all of the other thrust generators.

In such examples, decoupling all of the forces and moments on the multi-rotor helicopter is not possible since the expression of such a system would be underdetermined (i.e., there would be more unknowns than there would be equations). However, a system designer may select certain forces and/or moments to control independently, still yielding performance advantages in certain scenarios.

It should be understood that the configuration of the thrust locations, thrust directions, motor directions of rotation, and maximum rotation speed or thrust produced by each motor can be selected according to various criteria, while maintaining the ability to control the multiple (e.g., six) motor speeds according to net linear thrust force (e.g. three constraints) and net torque (e.g., a further three constraints). In some examples, all the motors rotate in the same direction. For a given set of thrust locations (e.g., a symmetric arrangement with the thrust locations at a fixed radius and spaced at 60 degrees), the thrust direction are selected according to a design criterion. For example, the thrust directions are selected to provide equal thrust in a hover mode with the net force being vertical and no net torque. In some examples, the thrust directions are selected to achieve a desired controllability “envelope”, or optimize such an envelope subject to a criterion or a set of constraints, of achievable net thrust vectors given constraints on the motor rotation speeds. As an example, the following set of thrust directions provides equal torque and common rotation direction in a hover mode:

In one exemplary configuration, the twist angles are equal, but changing in sign. For example, the dihedral angle for each of the motors is +15 degrees, and the twist angle for the motors alternates between +/−15 degrees. For this exemplary configuration, the matrix

$$[ \begin{matrix}- 2.50 & - 0.72 & 6.79 & 0.63 & 1.18 & 0.18 \\ 2.50 & - 0.72 & - 6.79 & 0.63 & - 1.18 & 0.18 \\ 1.87 & - 1.81 & 6.79 & - 1.33 & - 0.05 & 0.18 \\ - 0.63 & 2.52 & - 6.79 & 0.71 & 1.13 & 0.18 \\ 0.63 & 2.52 & 6.79 & 0.71 & - 1.13 & 0.18 \\ - 1.87 & - 1.81 & - 6.79 & - 1.33 & 0.05 & 0.18\end{matrix} ]$$

satisfies all of the above conditions.

If, however, the dihedral angle for the above configuration is −15, then the matrix

$$[ \begin{matrix}0.63 & - 2.52 & 6.79 & 0.71 & 1.13 & 0.18 \\ - 0.63 & - 2.52 & - 6.79 & 0.71 & - 1.13 & 0.18 \\ 1.87 & 1.81 & 6.79 & - 1.33 & 0.05 & 0.18 \\ 2.5 & 0.72 & - 6.79 & 0.63 & 1.18 & 0.18 \\ - 2.50 & 0.72 & 6.79 & 0.63 & - 1.18 & 0.18 \\ - 1.87 & 1.81 & - 6.79 & - 1.33 & - 0.05 & 0.18\end{matrix} ]$$

satisfies all of the above conditions.

In another exemplary configuration, the dihedral angle is +15, the propellers all spin counter-clockwise, and the twist angle for the motors alternates between −22 and +8 degrees, then the matrix

$$[ \begin{matrix}1.18 & - 1.92 & 3.69 & 0.78 & 1.16 & 0.18 \\ - 0.16 & - 3.43 & - 3.46 & 0.78 & - 1.16 & 0.18 \\ 1.08 & 1.98 & 3.69 & - 1.39 & 0.10 & 0.18 \\ 3.05 & 1.58 & - 3.46 & 0.61 & 1.25 & 0.18 \\ - 2.25 & - 0.06 & 3.69 & 0.61 & - 1.25 & 0.18 \\ - 2.89 & 1.85 & - 3.46 & - 1.39 & - 0.10 & 0.18\end{matrix} ]$$

satisfies all of the above conditions.

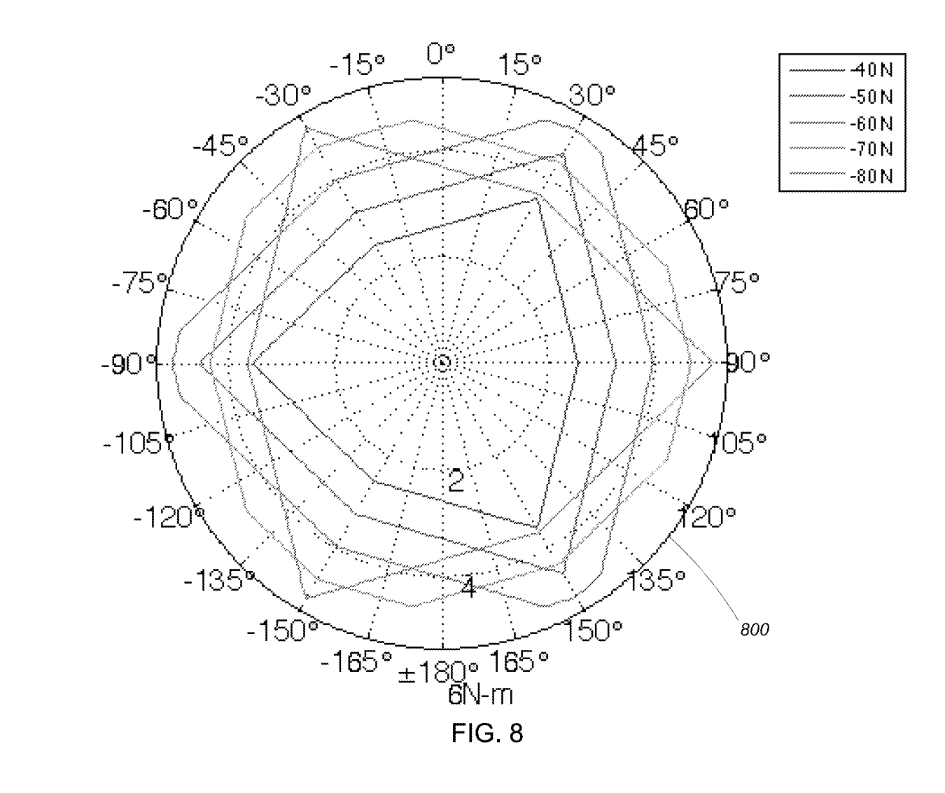

Referring to FIGS. 8-11, a number of plots illustrate a controllability envelope for an aerial vehicle configured with its motors spinning in alternating directions, a 15 degree dihedral angle, and alternating 15 degree twist angle. In the configuration shown in the figures, the yaw torque on the vehicle is commanded to be 0 Nm and the propeller curve for a 17×9″ propeller is used. Note that the propeller constant does not affect generality.

Referring to FIG. 8, a plot 800 shows a roll and pitch controllability envelope in Nm at various vehicle weights, with no lateral thrust being generated.

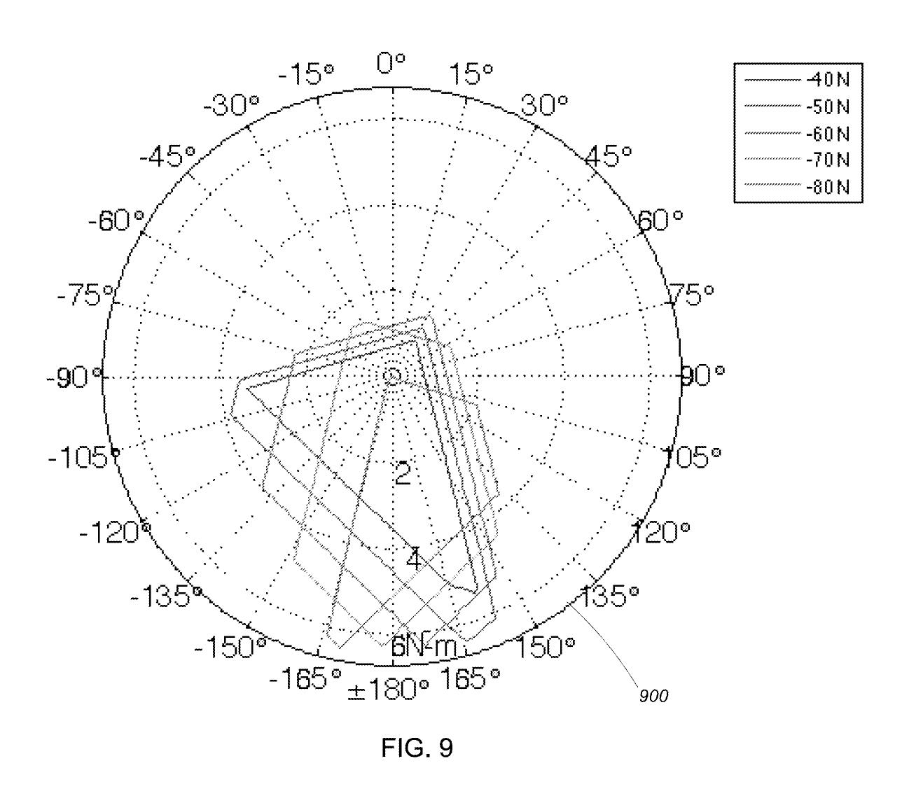

Referring to FIG. 9, a plot 900 shows a roll and pitch controllability envelope in Nm at various vehicle weights with a 1 m/s² rightward thrust being generated.

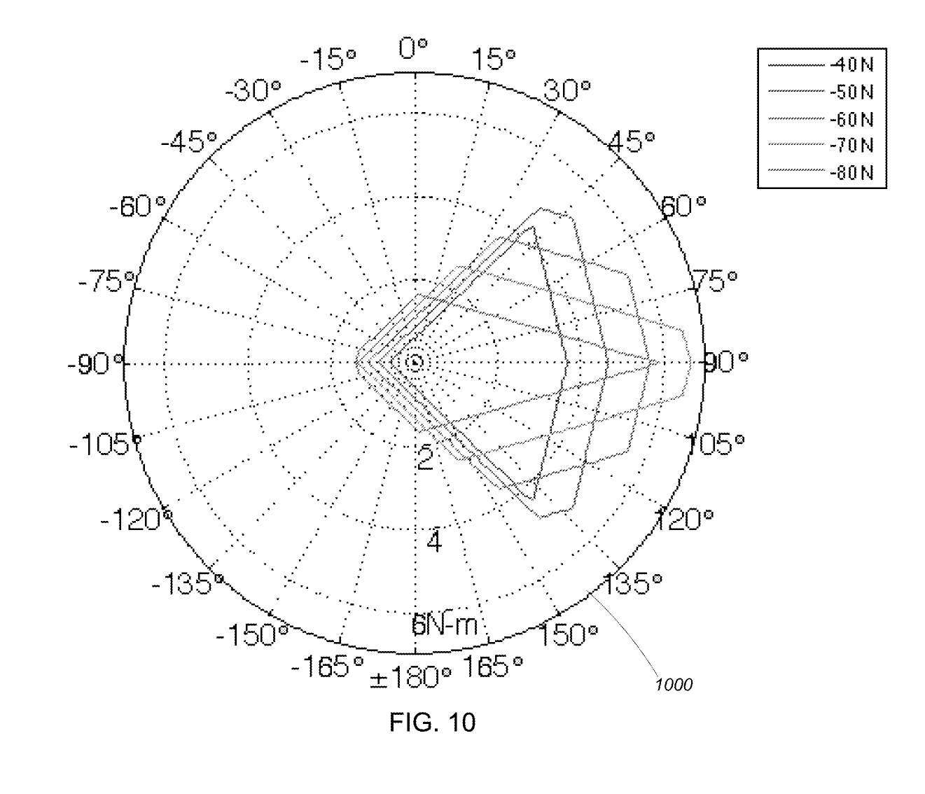

Referring to FIG. 10, a plot 1000 shows a roll and pitch controllability envelope in Nm at various vehicle weights with a 1 m/s² forward thrust being generated.

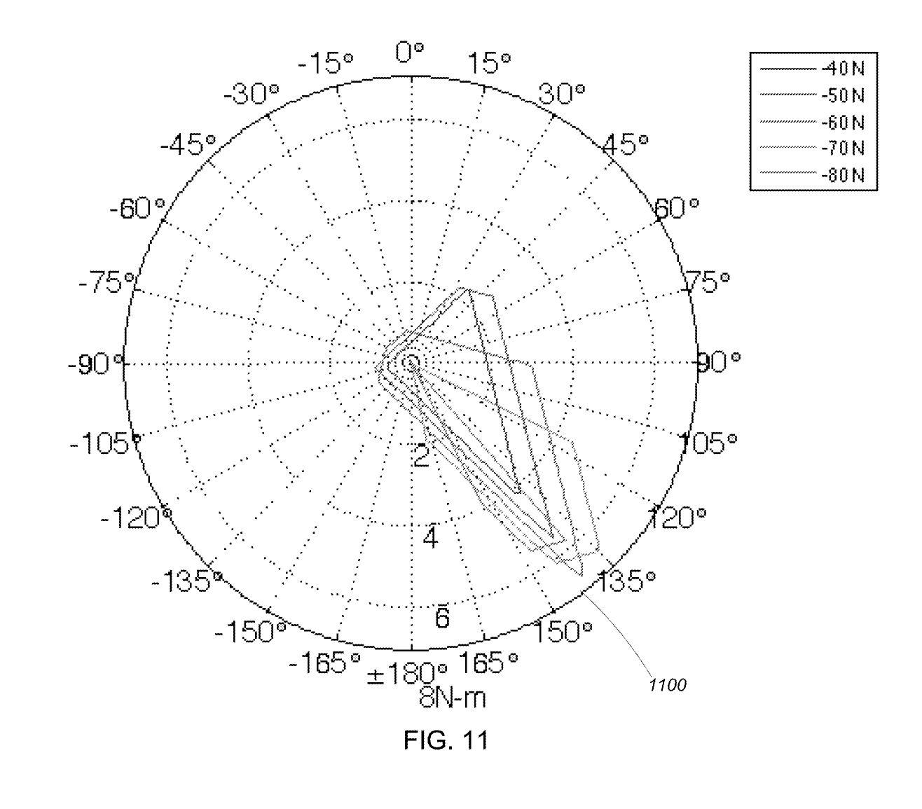

Referring to FIG. 11, a plot 1100 shows a roll and pitch controllability envelope in Nm at various vehicle weights with a 1 m/s² forward thrust and 1 m/s² right thrust being generated.

It is to be understood that the foregoing description is intended to illustrate and not to limit the scope of the invention, which is defined by the scope of the appended claims. Other embodiments are within the scope of the following claims.

1.-24. (canceled)

25. A multi-rotor aerial vehicle comprising:
a body;
a plurality of spatially separated thrusters statically coupled to the body, each thruster comprising a rotor coupled to a motor, the thrusters configured to emit thrust along a corresponding plurality of different thrust vectors having at least pitch and yaw components; and
a control system configured to individually control an angular speed of each motor for the plurality of spatially separated thrusters to control flight of the multi-rotor aerial vehicle.

26. The multi-rotor aerial vehicle of claim 25, wherein each thruster is statically coupled to the body at a dihedral angle and wherein the plurality of spatially separated thrusters comprises four thrusters, six thrusters, eight thrusters or ten thrusters.

27. The multi-rotor aerial vehicle of claim 25, wherein the body has a center and each rotor has a center and defines a rotational plane, and wherein each rotor is statically coupled to the body at a nonzero dihedral angle as measured between a line connecting the center of the rotor and the center of the body and the rotational plane of the rotor.

28. The multi-rotor aerial vehicle of claim 25, further comprising a plurality of spars extending from the body and defining a plane of the multi-rotor aerial vehicle, each thruster mounted to a corresponding spar with a nonzero dihedral angle between a rotational plane of the rotor and the plane of the multi-rotor aerial vehicle.

29. The multi-rotor aerial vehicle of claim 28, wherein each thruster is mounted to a corresponding spar at a twist angle such that a thrust vector of the thruster is rotated away from the normal to the plane of the multi-rotor aerial vehicle by the twist angle about a longitudinal axis of the spar.

30. The multi-rotor aerial vehicle of claim 25, further comprising a plurality of spars defining a plane of the multi-rotor aerial vehicle, each rotor mounted to a corresponding spar at a twist angle such that the rotor rotational axis is rotated away from the normal to the plane of the multi-rotor aerial vehicle by the twist angle about a longitudinal axis of the spar.

31. The multi-rotor aerial vehicle of claim 30, wherein a magnitude of the twist angle is 15°.

32. The multi-rotor aerial vehicle of claim 30, wherein the twist angle is in a range of 8° to −22°.

33. The multi-rotor aerial vehicle of claim 25, wherein the control system is configured to independently control a position of the multi-rotor aerial vehicle and an orientation of the multi-rotor aerial vehicle during flight through individual control of an angular speed of the motor for each of the spatially separated thrusters.

34. The multi-rotor aerial vehicle of claim 25, wherein the control system is configured change a position of the position of the multi-rotor aerial vehicle while maintaining an orientation of the multi-rotor aerial vehicle during flight through individual control of an angular speed of the motor for each of the spatially separated thrusters.

35. The multi-rotor aerial vehicle of claim 25, wherein the control system is configured maintain a position of the position of the multi-rotor aerial vehicle while changing an orientation of the multi-rotor aerial vehicle during flight through individual control of an angular speed of the motor for each of the spatially separated thrusters.

36. The multi-rotor aerial vehicle of claim 25, wherein the control system is configured to independently control a net force vector on the vehicle due to the thrusters and a net moment vector on the vehicle due to the thrusters through individual control of an angular speed of the motor for each of the spatially separated thrusters.

37. The multi-rotor aerial vehicle of claim 25, wherein the control system is configured to individually control an angular speed of each motor for the plurality of spatially separated thrusters to:
change a net force vector a net force vector on the vehicle due to the thrusters while maintaining a net moment vector on the vehicle due to the thrusters, or
change a net moment vector a net force vector on the vehicle due to the thrusters while maintaining a net force vector on the vehicle due to the thrusters.

38. The multi-rotor aerial vehicle of claim 38, wherein the control system is configured to individually control an angular speed of each motor for the plurality of spatially separated thrusters to:
change the net force vector on the vehicle due to the thrusters while maintaining the net moment vector on the vehicle due to the thrusters, and
change the net moment vector on the vehicle due to the thrusters while maintaining the net force vector on the vehicle due to the thrusters.

39. The multi-rotor aerial vehicle of claim 25, wherein the control system is configured to change a net force vector on the vehicle due to the thrusters while maintaining an orientation of the aerial vehicle by individually controlling an angular speed of each motor for the plurality of spatially separated thrusters.

40. The multi-rotor aerial vehicle of claim 25, wherein the control system is configured to change an orientation of the aerial vehicle while maintaining a net force vector on the vehicle due to the thrusters by individually controlling an angular speed of each motor for the plurality of spatially separated thrusters.

41. The multi-rotor aerial vehicle of claim 25, wherein the control system is configured to maintain a position and maintain an orientation of the aerial vehicle during flying while the aerial vehicle is subjected to an external force having a time-varying horizontal component.

42. The multi-rotor aerial vehicle of claim 25, wherein the control system comprises:
a first control module; and
an error signal module configured to provide information regarding a current position and/or a current orientation of the vehicle to the first control module;
wherein the control system is configured to receive a control signal including information regarding a desired position and a desired orientation for the vehicle;
wherein the first control module is configured to:
store information regarding a current force vector and a current moment vector; and
determine a desired differential force vector and a desired differential moment vector based on the desired position, the desired orientation, the current position, the current orientation, the current force vector and the current moment vector; and
wherein the control system is further configured to adjust the angular speed of each motor based on the determined desired differential force vector and the determined desired differential moment vector.

43. The multi-rotor aerial vehicle of claim 42, further comprising an imaging sensor coupled to the body, wherein the error signal module receives information regarding a current position or a current orientation of the aerial vehicle from the imaging sensor.

44. The multi-rotor aerial vehicle of claim 42, wherein the control system further comprises a second controller module configured to determine a desired differential angular speed for each motor based on the desired differential force vector and the desired differential moment vector.

45. The multi-rotor aerial vehicle of claim 25, further comprising an imaging sensor.

46. The multi-rotor aerial vehicle of claim 45, wherein the imaging sensor is statically coupled to the body or is coupled to the body by a gimbal mount.

47. The multi-rotor aerial vehicle of claim 25, wherein each thruster is configured to emit thrust along a corresponding thrust vector with a direction of each thrust vector being different than a direction of every other thrust vector for the plurality of spatially separated thrusters

48. The multi-rotor aerial vehicle of claim 47, wherein all of the thrust vectors have a shared primary component in a first direction.

49. The multi-rotor aerial vehicle of claim 25, wherein the motors of all of the thrusters rotate in a same direction or the motors of a first subset of the plurality of thrusters rotate in a first direction and the motors of a second subset of the plurality of thrusters rotate in a second direction, different from the first direction.

50. A multi-rotor aerial vehicle comprising:
a body;
a plurality of spars extending from the body and defining a plane of the multi-rotor aerial vehicle;
a plurality of spatially separated thrusters, each thruster mounted to a corresponding spar of the plurality of spars such that a thrust vector of the thruster is rotated away from the normal to the plane of the multi-rotor aerial vehicle by the twist angle about a longitudinal axis of the spar; and
a control system configured to individually control an angular speed of each motor for the plurality of spatially separated thrusters to control flight of the multi-rotor aerial vehicle.

51. The multi-rotor aerial vehicle of claim 50, wherein the twist angle is in a range of 8° to −22°.

52. The multi-rotor aerial vehicle of claim 50, wherein the control system comprises:
a first control module; and
an error signal module;
wherein the control system is configured to receive a control signal including information regarding a desired position and a desired orientation for the vehicle;
wherein the error signal module is configured to provide information regarding a current position and a current orientation of the vehicle to the first control module;
wherein the first control module is configured to:
store information regarding a current force vector and a current moment vector; and
determine a desired differential force vector and a desired differential moment vector based on the desired position, the desired orientation, the current position, the current orientation, the current force vector and the current moment vector; and
wherein the control system is configured to adjust the angular speed of each motor based on the determined desired differential force vector and the determined desired differential moment vector.

53. The multi-rotor aerial vehicle of claim 52, further comprising an imaging sensor coupled to the body, wherein the error signal module receives information regarding a current position or a current orientation of the aerial vehicle from the imaging sensor.

54. The multi-rotor aerial vehicle of claim 52, wherein the control system further comprises a second controller module configured to determine a desired differential angular speed for each motor based on the desired differential force vector and the desired differential moment vector.

55. The multi-rotor aerial vehicle of claim 50, wherein the plurality of spatially separated thrusters comprises four, six, eight or ten thrusters and all of the thrust vectors have a shared primary component in a vertical direction.

56. The multi-rotor aerial vehicle of claim 52, wherein each thruster is configured to emit thrust along a corresponding thrust vector with a direction of each thrust vector being different than a direction of every other thrust vector for the plurality of spatially separated thrusters.

57. A multi-rotor aerial vehicle comprising:
a body; and
a plurality of spatially separated thrusters statically coupled to the body, each thruster comprising a rotor coupled to a motor, the thrusters configured to emit thrust along a plurality of different thrust vectors; and
a control system configured to individually control an angular speed of each motor for the plurality of spatially separated thrusters to control flight of the multi-rotor aerial vehicle, the control system including an error signal module configured to provide information regarding a current position and a current orientation of the vehicle for adjustment of a position of the aerial vehicle, an orientation of the aerial vehicle, or both by the control system.

58. The multi-rotor aerial vehicle of claim 57, further comprising an imaging sensor coupled to the body, wherein the information provided by the error signal module is based, at least in part, on data from the imaging sensor.

59. The multi-rotor aerial vehicle of claim 57, the control system is configured to:
receive a control signal including information regarding a desired position and a desired orientation for the vehicle and wherein the control system further comprises a first control module, the first control module configured to:
store information regarding a current force vector and a current moment vector; and
determine a desired differential force vector and a desired differential moment vector based on the desired position, the desired orientation, the current position, the current orientation, the current force vector and the current moment vector; and
wherein the control system is configured to adjust the angular speed of each motor based on the determined desired differential force vector and the determined desired differential moment vector.

60. The multi-rotor aerial vehicle of claim 59, wherein the control system further comprises a second controller module configured to determine a desired differential angular speed for each motor based on the desired differential force vector and the desired differential moment vector.

61. The multi-rotor aerial vehicle of claim 57, further comprising a plurality of spars defining a plane of the multi-rotor aerial vehicle, each rotor mounted to a corresponding spar at a twist angle such that the rotor rotational axis is rotated away from the normal to the plane of the multi-rotor aerial vehicle by the twist angle about a longitudinal axis of the spar and wherein the plurality of spatially separated thrusters comprises four, six, eight or ten thrusters and all of the thrust vectors have a shared component in a first direction.

62. The multi-rotor aerial vehicle of claim 61, wherein the twist angle is in a range of 8° to −22°.

63. The multi-rotor aerial vehicle of claim 57, wherein each thruster is configured to emit thrust along a corresponding thrust vector with a direction of each thrust vector being different than a direction of every other thrust vector for the plurality of spatially separated thrusters.

64. A multi-rotor aerial vehicle comprising:
a body; and
a plurality of spatially separated thrusters statically coupled to the body, each thruster comprising a rotor coupled to a motor, the thrusters configured to emit thrust along a plurality of different thrust vectors; and
a control system configured to individually control an angular speed of each motor for the plurality of spatially separated thrusters to control flight of the multi-rotor aerial vehicle and to operate in at least two different modes including:
a first mode in which the spatially separated thrusters are individually controlled to independently control a net force vector generated by the thrusters and a net moment vector generated by the thrusters; and
a second mode in which the spatially separated thrusters are controlled to change a net force vector generated by the thrusters, in part, by changing a roll, yaw or pitch orientation of the aerial vehicle.

65. The multi-rotor aerial vehicle of claim 64, wherein the control system is configured to change operation from a first mode to a second mode when an angular speed required of any of the motors would exceed a specified value.

66. The multi-rotor aerial vehicle of claim 64, wherein the control system comprises:
a first control module; and
an error signal module;
wherein the control system is configured to receive a control signal including information regarding a desired position and a desired orientation for the vehicle;
wherein the error signal module is configured to provide information regarding a current position and a current orientation of the vehicle to the first control module;
wherein the first control module is configured to:
store information regarding a current force vector and a current moment vector; and
determine a desired differential force vector and a desired differential moment vector based on the desired position, the desired orientation, the current position, the current orientation, the current force vector and the current moment vector; and
wherein the control system is configured to adjust the angular speed of each motor based on the determined desired differential force vector and the determined desired differential moment vector.

67. The multi-rotor aerial vehicle of claim 66, further comprising an imaging sensor coupled to the body, wherein the error signal module receives information regarding a current position or a current orientation of the aerial vehicle from the imaging sensor and wherein the control system further comprises a second controller module configured to determine a desired differential angular speed for each motor based on the desired differential force vector and the desired differential moment vector.

68. The multi-rotor aerial vehicle of claim 64, further comprising a plurality of spars defining a plane of the multi-rotor aerial vehicle, each rotor mounted to a corresponding spar at a twist angle such that the rotor rotational axis is rotated away from the normal to the plane of the multi-rotor aerial vehicle by the twist angle about a longitudinal axis of the spar.

69. The multi-rotor aerial vehicle of claim 64, wherein the twist angle is in a range of 8° to −22°.

70. The multi-rotor aerial vehicle of claim 64, wherein each thruster is configured to emit thrust along a corresponding thrust vector with a direction of each thrust vector being different than a direction of every other thrust vector for the plurality of spatially separated thrusters and wherein all of the thrust vectors have a shared component in a first direction.

71. A method for operating a multi-rotor aerial vehicle including a body and a plurality of spatially separated thrusters coupled to the body, each thruster comprising a rotor coupled to a motor, the thrusters configured to emit thrust along a plurality of different thrust vectors, the method comprising:
receiving an indication of a desired position for the aerial vehicle and a desired orientation for the roll, yaw and pitch of the aerial vehicle; and
individually controlling an angular speed of each motor for the spatially separated thrusters with a control system to achieve and maintain the desired position and the desired orientation for the aerial vehicle.

72. The method of claim 71, wherein individually controlling the angular speed of each motor for the spatially separated thrusters to achieve and maintain the desired position and the desired orientation for the aerial vehicle comprises determining or receiving information regarding a current position of the aerial vehicle and a current orientation of the aerial vehicle.

73. The method of claim 72, wherein the multi-rotor aerial vehicle includes an imaging device coupled to the body, and wherein the information regarding the current position of the aerial vehicle and the current orientation of the aerial vehicle is based, at least in part, on information from the imaging device.

74. The method of claim 72, wherein individually controlling the angular speed of each motor for the spatially separated thrusters to achieve and maintain the desired position and the desired orientation for the aerial vehicle further comprises:
storing information regarding a current force vector and a current moment vector; and
determining a desired differential force vector and a desired differential moment vector based on the desired position, the desired orientation, the current position, the current orientation, the current force vector, and the current moment vector.

75. The method of claim 74, wherein individually controlling the angular speed of each motor for the spatially separated thrusters to achieve and maintain the desired position and the desired orientation for the aerial vehicle further comprises determining a desired differential angular speed for each motor based on the desired differential force vector and the desired differential moment vector.

76. The method of claim 75, wherein individually controlling the angular speed of each motor for the spatially separated thrusters to achieve and maintain the desired position and the desired orientation for the aerial vehicle further comprises:
modifying the angular speed of each motor based on the desired differential angular speed for each motor; and
determining or obtaining new current position and new current orientation information for further modification of the angular speed of each rotor based on a difference between the desired position and the new current position and a difference between the desired orientation and the new current orientation.

77. The method of claim 72, wherein individually controlling the angular speed of each motor for the spatially separated thrusters to achieve and maintain the desired position and the desired orientation for the aerial vehicle further comprises:
determining a net force vector and a net moment vector based on the desired position, the current position, the desired orientation, and the current orientation; and
causing the plurality of spatially separated thrusters to generate the net force vector and the net moment vector.

78. The method of claim 77, wherein individually controlling the angular speed of each motor for the spatially separated thrusters to achieve and maintain the desired position and the desired orientation for the aerial vehicle further comprises:
determining a further orientation and a further position of the vehicle; and
modifying a net force vector and a net moment vector generated by the thrusters based on a difference between the desired position and the further position and a difference between the desired orientation and the further orientation.

79. The method of claim 71, wherein each thruster is configured to emit thrust along a corresponding thrust vector with a direction of each thrust vector being different than a direction of every other thrust vector for the plurality of spatially separated thrusters and wherein all of the thrust vectors have a shared component in a first direction.

80. The method of claim 78, wherein the body has a center and a plurality of spatially separated thrusters coupled to the body at locations around the center of the body, and wherein the method further comprises:
individually controlling an angular speed of each motor for the plurality of spatially separated thrusters to maintain the desired position to reduce changing a roll, pitch or yaw orientation of the aerial vehicle.

81. The method of claim 80, wherein individually controlling the angular speed of each motor for the spatially separated thrusters to achieve and maintain the desired position or orientation of the aerial vehicle comprises:
determining a differential thrust force vector based on the desired position for the aerial vehicle, the current position for the aerial vehicle, and a current thrust force vector;
determining a differential moment vector based on the desired orientation for the aerial vehicle, the current orientation of the aerial vehicle, and the current moment vector; and
determining a differential in the output for each thruster based on the differential thrust vector and the differential moment vector.

82. The method of claim 81, further comprising obtaining or generating information regarding the current position and the current orientation of the aerial vehicle; wherein the multi-rotor aerial vehicle includes an imaging sensor coupled to the body; and wherein the information regarding the current position of the aerial vehicle and the current orientation of the aerial vehicle is based, at least in part, on information from the imaging sensor.

83. The method of claim 71, further comprising storing a current thrust force vector and a current moment vector.

84. The method of claim 81, wherein individually controlling the angular speed of each motor for the spatially separated thrusters to achieve and maintain the desired position and the desired orientation for the aerial vehicle further comprises:
modifying the output for each thruster based on the determined differential in the output;
measuring or receiving an indication of a further current position and further current orientation after modification of the outputs of the thrusters; and
further modifying the output for each thruster based, at least in part, on a difference between the desired position and the further current position and a difference between the desired orientation and the further current orientation.

85. The multi-rotor aerial vehicle of claim 80, wherein all of the thrust vectors have a shared primary component in a first direction.

86. A method for stability control in a multi-rotor aerial vehicle including a body having a center and a plurality of spatially separated thrusters statically coupled to the body at locations around the center of the body, each thruster comprising a rotor coupled to a motor and each thruster configured to emit thrust along a corresponding thrust vector with a direction of each thrust vector being different than a direction of every other thrust vector for the plurality of spatially separated thrusters, the method comprising:
receiving an indication of a desired position for the aerial vehicle and a desired orientation for the roll, yaw and pitch of the aerial vehicle;
determining an output required for each thruster to achieve or maintain the desired position of the aerial vehicle and the desired orientation of the aerial vehicle;
determining if the output required for any of the thrusters would exceed a specified value; and
if the output required would not exceed the specified value for any of the thrusters, individually controlling the thrusters to achieve or maintain the desired position of the aerial vehicle and achieve or maintain the desired orientation of the aerial vehicle; or
if the output required would exceed the specified value for any of the thrusters individually controlling the thrusters to achieve or maintain the desired position of the aerial vehicle by changing the orientation of the aerial vehicle to deviate from the desired orientation.

87. The method of claim 86, wherein individually controlling the thrusters to achieve or maintain the desired position of the aerial vehicle and achieve or maintain the desired orientation of the aerial vehicle comprises determining or receiving information regarding a current position of the aerial vehicle and a current orientation of the aerial vehicle.

88. The method of claim 87, wherein the multi-rotor aerial vehicle includes an imaging device coupled to the body, and wherein the information regarding the current position of the aerial vehicle and the current orientation of the aerial vehicle is based, at least in part, on information from the imaging device.

89. The method of claim 87, wherein individually controlling the thrusters to achieve or maintain the desired position of the aerial vehicle and achieve or maintain the desired orientation of the aerial vehicle further comprises:
storing information regarding a current force vector and a current moment vector; and
determining a desired differential force vector and a desired differential moment vector based on the desired position, the desired orientation, the current position, the current orientation, the current force vector, and the current moment vector.

90. The method of claim 89, wherein individually controlling the thrusters to achieve or maintain the desired position of the aerial vehicle and achieve or maintain the desired orientation of the aerial vehicle further comprises determining a desired differential angular speed for each motor based on the desired differential force vector and the desired differential moment vector.

91. The method of claim 90, wherein individually controlling the thrusters to achieve or maintain the desired position of the aerial vehicle and achieve or maintain the desired orientation of the aerial vehicle further comprises:
modifying the angular speed of each motor based on the desired differential angular speed for each motor; and
determining or obtaining new current position and new current orientation information for further modification of the angular speed of each rotor based on a difference between the desired position and the new current position and a difference between the desired orientation and the new current orientation.

92. The method of claim 91, wherein individually controlling the thrusters to achieve or maintain the desired position of the aerial vehicle and achieve or maintain the desired orientation of the aerial vehicle further comprises:
determining or obtaining new current position and new current orientation information for further modification of the angular speed of each rotor based on a difference between the desired position and the new current position and a difference between the desired orientation and the new current orientation; and
further modifying the angular speed of each motor based on a difference between the desired position and the new current position and a difference between the desired orientation and the new current orientation.

93. The method of claim 86, wherein the method is implemented by a control system of the vehicle.

94. The method of claim 86, wherein all of the thrust vectors have a shared primary component in a first direction.
